(19) United States
(12) Patent Application Publication
(10) Pub. No.: US 2023/0418970 A1
(43) Pub. Date: Dec. 28, 2023

(54) SELECTIVELY MASKING PERSONALLY IDENTIFIABLE INFORMATION

(71) Applicant: Marsh (USA) Inc., New York, NY (US)

(72) Inventors: Matthew S. Dobrin, Boulder, CO (US); Stephen Dantu, Bedford, NY (US); Sarah DeSantis-Sullivan, Scottsdale, AZ (US); Andy Hickman, Summit, NJ (US); Saurabh Jain, Scottsdale, AZ (US); Laurent Thanwerdas, Brooklyn, NY (US)

(73) Assignee: Marsh (USA) Inc., New York, NY (US)

(21) Appl. No.: 17/848,663

(22) Filed: Jun. 24, 2022

(51) Int. Cl. G06F 21/62

(52) U.S. Cl. CPC G06F 21/6245

(57) ABSTRACT

Systems and methods to mask Personally Identifiable Information (“PII”) without masking proximate context are provided. The system may create a raw data set using at least one data file including PII through an ingestion pipeline. The system may identify and categorize the type of PII to be masked and record the type of PII in a data field. The system may selectively mask the PII by analyzing at least one location to determine a context proximate to the PII and masking only the PII. The system may output a masked data set including the at least one data file with the PII selectively masked and the data field containing a record of the type of PII selectively masked.

### FIELD OF TECHNOLOGY

The present disclosure relates to a system and method for selectively masking personally identifiable information, and more particularly to systems and methods to selectively mask personally identifiable information.

### BACKGROUND

Systems and methods for masking Personally Identifiable Information (“PII”) often flag and encrypt entire sections of a document or data file if there is any suspicion the document may include PII. Systems known in the prior art were unable to selectively parse what is and is not PII leading to over-masking or under-masking. As a result, previous systems have left entire sections of documents encrypted and unusable without access to the decryption key. This drastically reduced the value of a data file or document by restricting access.

In other embodiments, previous systems could mask a section or field of a document by, for example, replacing the data with blackout or removing the data entirely. As a result, the context proximate to the PII was removed. Additionally, there would be no information as to the type of data removed for later review, even by authorized users. The context proximate to the PII—which may not include sensitive information—would be masked, reducing the value and comprehension of the data file or document.

Some known systems may detect sensitive information in a data set but are unable to mask the sensitive information. Instead, the entire document or data set must either be encrypted and rendered unusable or left unencrypted and vulnerable to unauthorized access. Other known systems could mask fields in a document, such as pre-identified places on a form for entry of a name or address. However, these systems relied on pre-identifying areas needing masking. They could not review a document or data set to determine locations containing PII or selectively mask the PII while preserving the context proximate to the PII.

These known systems created problems associated with being unable to share or use documents containing PII without also sharing decryption keys or leaving the document unmasked/unencrypted. These prior systems risked over-masking such that useful information was rendered inaccessible. Alternatively, prior systems risked under-masking a document and exposing sensitive information by failing to recognize PII not in pre-selected or pre-identified fields.

### SUMMARY

Aspects of the present disclosure provide content monitoring apparatus, systems and methods to selectively mask PII without removing proximate context, by providing a data file suspected to include PII through an ingestion pipeline and creating a raw data set for input processing. The raw data set received by the content monitoring system may be provided in an encrypted format. The raw data set may be decrypted if needed for analyzing the raw data set. The raw data set may be read and filtered to remove null fields, string containers, redundant data, or other impartial or unimportant data, during input processing to the content monitoring systems implementing methods to selectively mask PII without removing proximate context, according to the disclosure. The raw data set may be analyzed to determine the presence of PII and to determine at least one location having or including PII, if present.

Further, during input processing, the PII may be identified and categorized as a type of PII. Examples of types of PII include, but are not limited to: a name, a date, a location, a Social Security Number (SSN), an email, a zip code, and/or a phone number. The type of PII may be recorded in a data field.

According to one aspect of the present disclosure, PII in a data set may be selectively masked such that only the PII is masked without compromising the context proximate to the PII. The data set may be analyzed to determine a location including PII. The at least one location may be analyzed to determine the context proximate to the PII. The context may include information located at either side of the PII or proximate to the PII in the data set. The context may be configured to display in plain text, i.e., without encryption or other protection methods. The identified PII may be encrypted or protected to prevent access or viewing by an unauthorized user. An example of this protection is blanking out or redacting the location containing the identified PII.

According to another aspect of the present disclosure, an identifier including the type of PII selectively masked may be included at the location. A masked data set may be output alongside a reference table. The masked data set may have any PII selectively masked with the reference table including information identifying the type(s) of PII selectively masked. In an exemplary embodiment, the reference table may be used to store the masked PII for retrieval if an authorized user requests unmasking.

For example, if the PII identified is a name such as “Jane Smith,” the PII may be blanked and replaced with an indicator reading “NAME” to indicate the masked PII was a name. The masked data set may be configured to be de-masked by an authorized user reviewing the masked data set. The authorized user may determine what masked PII they desire to de-mask using the identifier. The authorized user may de-mask a single masked PII or de-mask based on the type of PII.

In another aspect, a non-transitory computer readable medium having program code recorded thereon may be configured to receive a raw data set and analyze the raw data set to identify at least one location including a PII. The raw data set may be decrypted if received in an encrypted state. The at least one location including the PII may be flagged to indicate the location contains PII. The non-transitory computer readable medium may be configured to identify a context proximate to the PII to prevent masking the context.

The non-transitory computer readable medium may be configured to determine the type of PII such as, but not limited to, those listed above. The non-transitory computer readable medium may be configured to selectively mask the PII. The mask may include an indicator to identify the type of PII masked. For example, if the PII identified is a name such as “Jane Smith,” the PII may be blanked and replaced with an indicator reading “NAME” to indicate the masked PII was a name. The masked PII may be written to a reference table for retrieval by authorized users during analysis of the masked data set.

According to another aspect of the present disclosure, the type of PII to be masked may be identified such that only a specified type of PII will be masked. As a result, the system, method and/or non-transitory computer readable medium may be configured to mask only certain types of PII. For example, a user may specify only names and addresses should be masked. Alternatively, only names may be selected to be masked.

The system, method and non-transitory computer readable medium may be configured to analyze the context at a location to identify the type of PII being masked. This may be needed in cases where there is overlap or similarities between different PII in a data set. For example, a street may be named Jane Street causing confusion as to whether the PII to be masked is a name or street. By using the context proximate to the PII the method and non-transitory computer readable medium may be configured to correctly identify the PII and indicate the type of PII masked.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other systems and methods for carrying out the same purposes of the present disclosure. It should also be realized by those skilled in the art that such equivalent systems and methods do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

The features, nature, and advantages of the present disclosure will become more apparent from the detailed description set forth below when taken in conjunction with the drawings, of which:

FIG. 1a is a functional block diagrammatic overview of a system and method for selectively masking PII according to one aspect of the present disclosure.

FIG. 1b is a functional block diagrammatic overview of a system and method for analyzing a raw data set to identify at least one location including PII, and identifying context around PII and determining type of PII at the at least one location, for selectively masking PII according to one aspect of the present disclosure.

FIG. 2 is a process block diagram of a system implementing a method for selectively masking PII according to one aspect of the present disclosure.

FIG. 3a is a schematic diagram of a system according to one aspect of the present disclosure.

FIG. 3b is a schematic diagram of a system according to another aspect of the present disclosure.

FIG. 4 is a flow diagram of a method of selectively masking a PII according to one aspect of the present disclosure.

### DETAILED DESCRIPTION

Several aspects of systems, apparatus and methods for selectively masking PII will now be presented with reference to the FIGS., briefly described above, which may, for example, be implemented in an improved computing system or apparatus. These systems, apparatus and methods will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Aspects of the present disclosure provide a system, apparatus and/or method of selectively masking PII. Embodiments of a system or apparatus implementing methods for selectively masking PII improve on current apparatus, systems and methods by enabling context analysis to identify PII and mask the PII without masking context proximate to the PII. As a result, the described systems, apparatus and methods prevent previous issues of over and under masking leading to the loss of non-PII or disclosure of protected information.

A data file suspected or expected to include PII and processed according to the apparatus, system and/or method disclosed may, for example, be output or otherwise processed from a medical database, insurance databases including claims, policies, exposures and insurance applications, employment information database or any sources of data (both batch and streaming data) that may be suspected or expected to include PII.

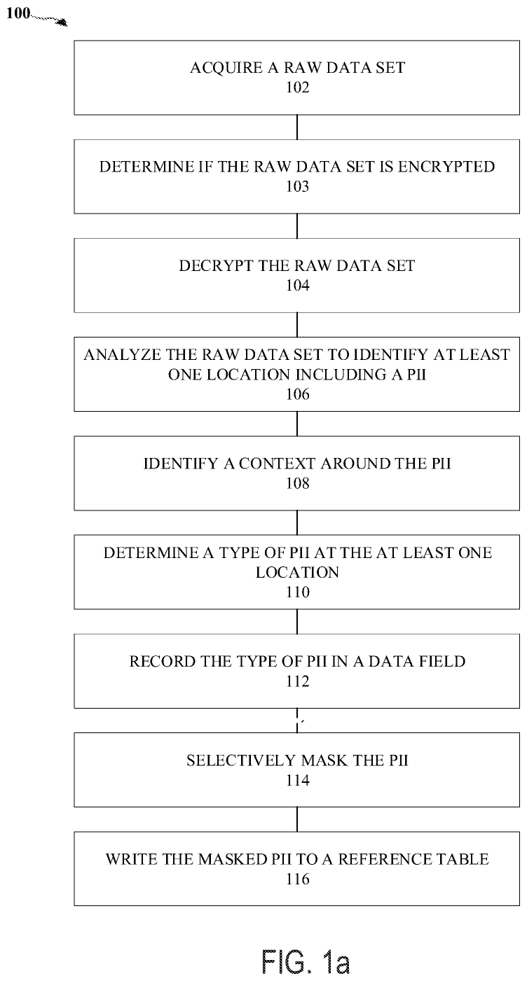

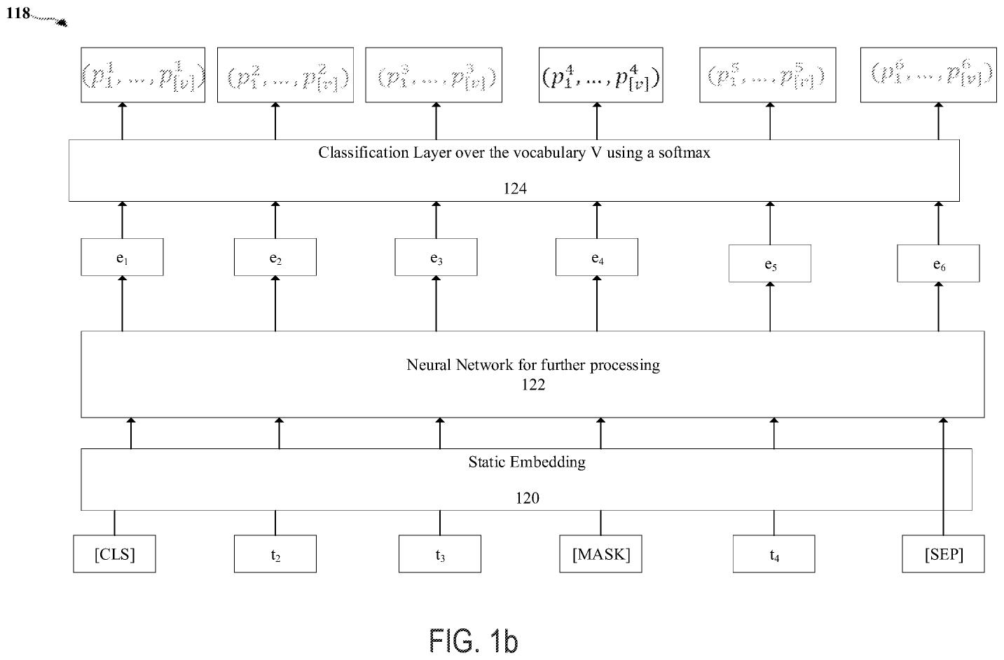

FIG. 1a is a block diagram of a system 100 for selectively masking PII according to one aspect of the present disclosure. At least one data file is provided 102 to form a raw data set. The raw data set may be analyzed for encryption 103. If the raw data set is determined to be encrypted, the raw data set may be decrypted 104 into an editable state for analysis. The raw data set is analyzed 106 to identify at least one location in the raw data set that has PII. A context proximate to the PII may be identified 108. For example, in a word based document, the context may include words before and after the identified PII.

The PII may be determined 110 to be a type of PII such as a name, address, SSN, etc. The type of PII may be recorded 112 in a data field. By determining 110 the type of PII at the location, the disclosure may determine what is part of the context and what is part of the PII at the location. For example, in a string sequence of:

“on the job, john smith lacerated his finger”

The context may be identified as:

“on the job, lacerated his finger”

Previous methods described in the Background have been unable to identify the PII within a data set and selectively mask only the PII. As a result, valuable information could be lost reducing the quality and value of the data set post-processing. For example, in the above string, traditional methods might detect the PII but would flag the entire string for encryption or would be unable to detect the PII because it isn't in a pre-defined field.

Additionally, by determining 110 the type of PII, the PII to be masked may be filtered. In other words, by categorizing the PII as discrete types of PII, masking 114 can be performed on only a subset of PII. As a result, an exemplary embodiment may be performed on only name PII or Social Security Number (SSN) PII. Thereby, leaving any other PII in the raw data set untouched. As part of different requirements for protection of PII, different regions and businesses have different rules for how PII is handled and the types of PII that need to be masked.

Additionally, if a raw data set is to be used in a study or other quantitative analysis, there may be certain types of information that must be masked while other types of information may need to be preserved to perform the analysis. For example, a study may need to mask any SSN PII, but removing location based PII may prevent geographic mapping of the raw data set limiting the usefulness of the study's results. By enabling selective masking to preserve context and avoid masking PII which is intended to be preserved, improvements over previous methods are achieved by an implementation according to the disclosure.

The PII may be selectively masked 114 to avoid masking the context at the location. The type of PII may be stored 116 in a reference table. In an exemplary embodiment, the unmasked PII may be stored 116 in a reference table for access by an authorized user with permissions to view the unmasked information. Thus, the need to encrypt the entire data set or to over-mask the location containing the PII is avoided. Similarly, the value of the data set may be preserved by storing the PII in a reference table to be accessed by authorized users.

Turning to FIG. 1B, a functional block diagrammatic overview of a system and method is illustrated, for analyzing a raw data set to identify at least one location including PII, and identifying context around PII and determining type of PII at the at least one location, for selectively masking PII according to one aspect of the present disclosure. The system 118 identifies the raw data set and maps an input string to assign tokens (e.g., words) that will provide information to model the distribution of a target token without unmasking the target itself. As a result, the tokens are statically embedded 120 in the data file for processing. Each token is processed 122 by a neural network designed to analyze the tokens against each other to preliminarily identify context and PII in the data set. The system 118 outputs the preliminarily identified context and PII to a classification layer 124 for verifying the identification of the context and PII in the string using a Softmax activation function. The Softmax function, as known in the art, creates a probabilistic analysis of the string by assigning the value—vocabulary V—to verify and/or identify the PII and the context in the input string. The system then layers 124 the verified classification over the data set. In doing so, the system 118 processes the context tokens to determine the distribution of one or several target tokens identifying the location of PII.

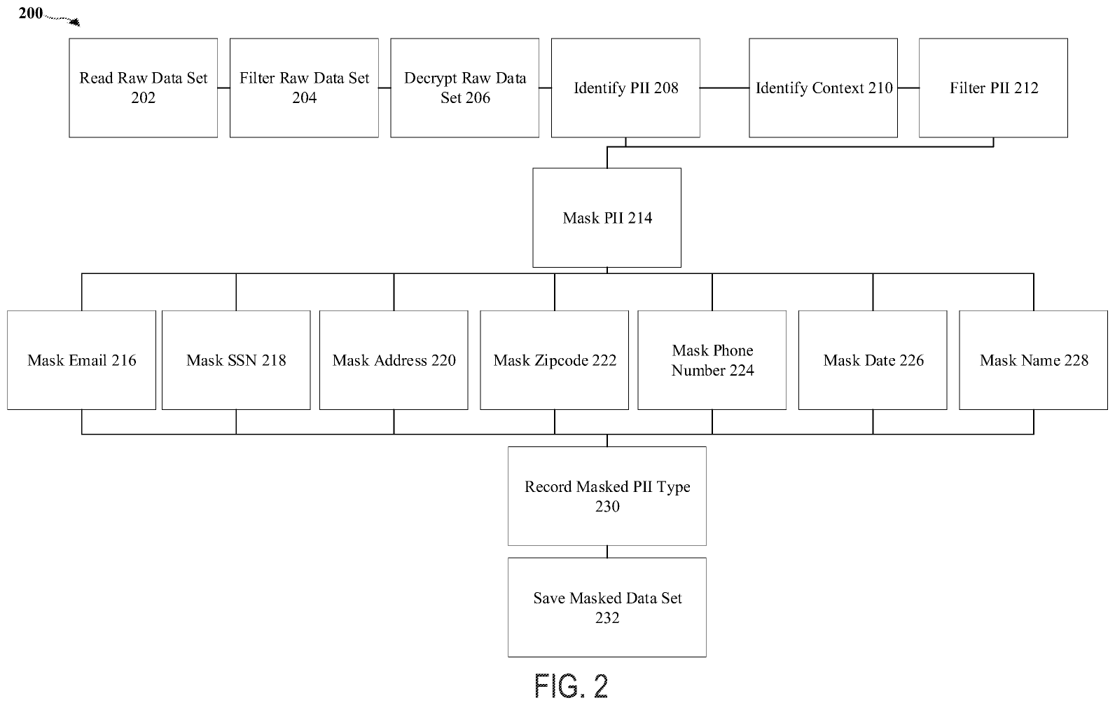

FIG. 2 illustrates a process flow diagram of a system 200 for selectively masking PII according to one aspect of the present disclosure. A raw data set is provided and read 202. The raw data set may be filtered 204 and cleaned up to remove null fields, string containers, redundant data, or other impartial or unimportant data. If the raw data set is determined to be encrypted, the raw data set may be decrypted 206 for analysis. According to the disclosure PII may be identified 208 in the raw data set, using the implementation and methodology illustrated and described with respect to FIG. 1B, discussed above. A context proximate to the PII may be identified 210. In a word based document, the context may include text to the left or right of the PII.

For example, in a string sequence of:

“on the job, john smith lacerated his finger”

The context may be identified as:

“on the job, lacerated his finger”

The PII may be identified as “john smith” and determined to be the name PII type. If other PII is present in the raw data set, the type of PII may be determined and only pre-selected types of PII flagged for masking through filtering 212. The PII may be masked 214 to remove the PII from view or analysis to prevent disclosure of the PII to non-authorized users of the data set.

For example, aspects of the present disclosure may identify and mask individual occurrences of PII within the data set or a combination of PII including: email 216, SSN 218, address 220, zipcode 222, phone number 224, date 226, and/or name 228. Such instances or examples of PII are not an exhaustive list, and instances of PII may be different or include other personally identifiable information, as a function of application, such as medical conditions, family members, financial information, licensing information, or the like.

The type of masked PII may be recorded 230 in a reference table. The masked data set with selective masked PII may be saved 232 for further use and/or processing. For example, the masked PII data set may be output to a graphical user interface for display to a user. The masked PII data set may be stored to a server or distributed to identified parties. If the parties do not have authorization to access and view the unmasked PII the reference table may be stored separately and securely to prevent unauthorized access. An identifier may be placed at the masked location in the data set. For example, a selectively masked data set including the above string may be masked for names to have an output masked data set of:

“on the job, [NAME] lacerated his finger”

If a user has authorization they may access the reference table to unmask the PII. The identifier enables a user to identify locations with masked PII relevant to their inquiry thereby reducing the amount of data they need to unmask to find relevant information. As some users may only be authorized to access some types of PII, the identifier helps ensure the user does not unmask PII they are not allowed to access. Additionally, by recording the type of PII at a masked location, the need for unmasking to determine the masked data may be avoided.

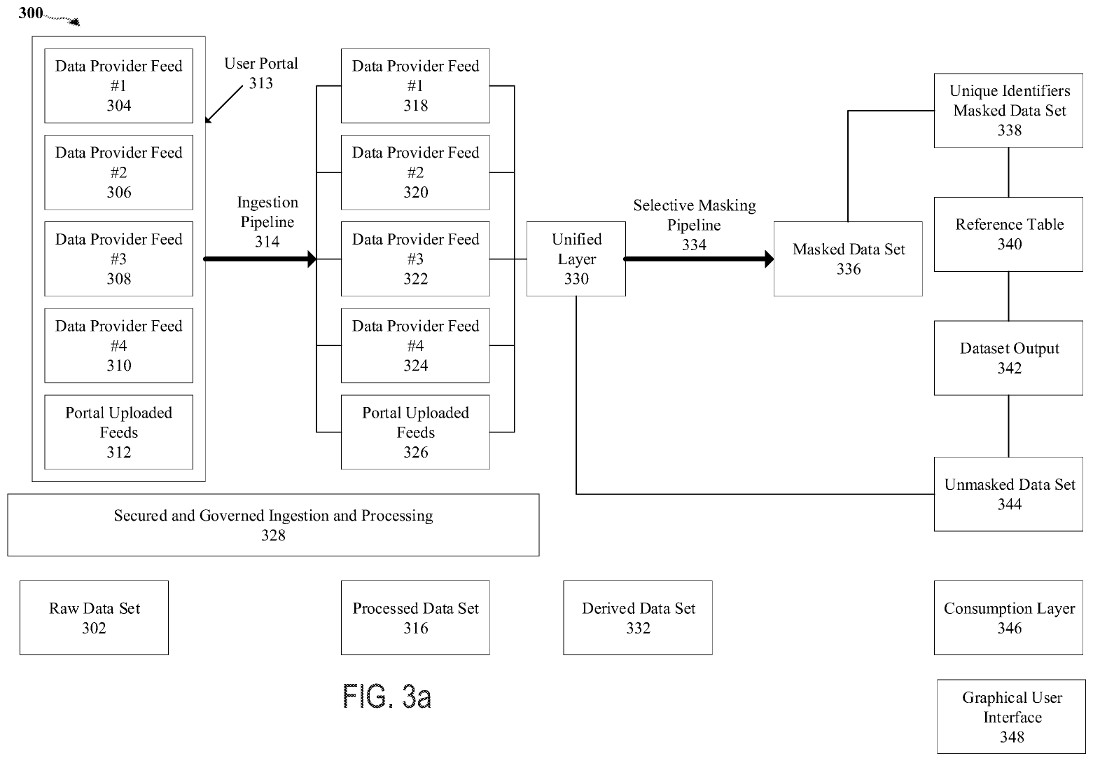

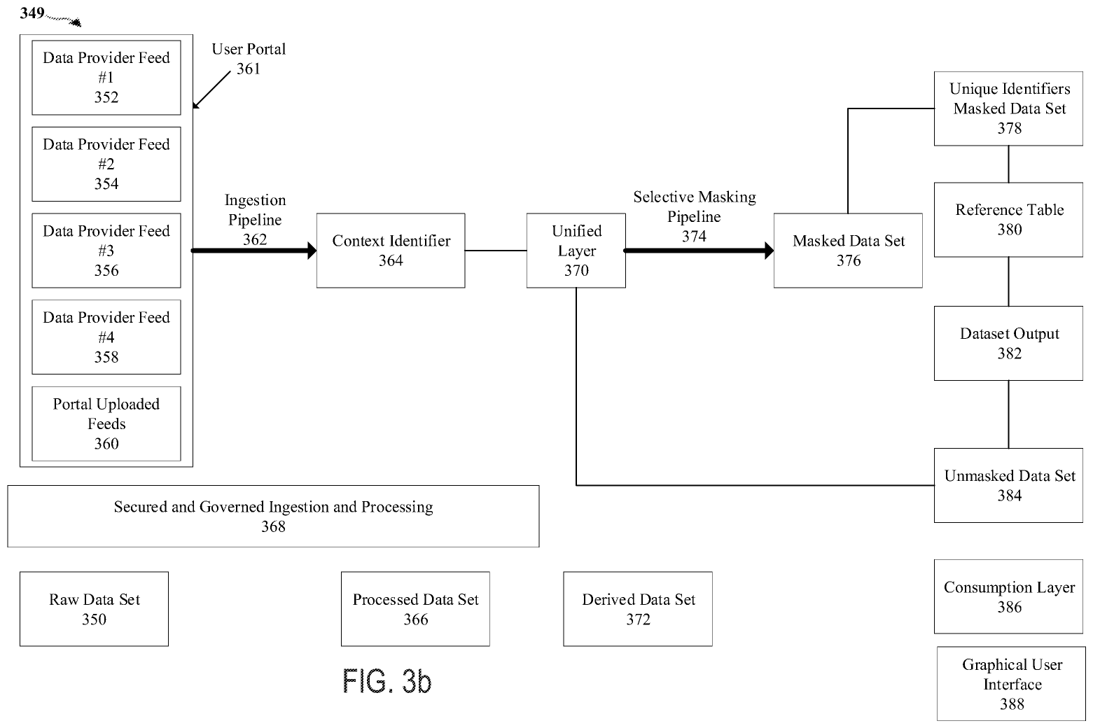

FIG. 3a is a schematic diagram of a system 300 according to one aspect of the present disclosure. A raw data set 302 may be provided. An exemplary embodiment may include the raw data set 302 comprising a data provider feed #1, 304, a data provider feed #2, 306, a data provider feed #3, 308, a data provider feed #4, 310, and portal uploaded feeds 312 from a user portal. The raw data set 302 may be received through an ingestion pipeline 314. The raw data set may be filtered to create a processed data set 314. An exemplary embodiment may include a raw data set 302 comprising a data provider feed #1, 318, a data provider feed #2, 320, a data provider feed #3, 322, a data provider feed #4, 324, and portal uploaded feeds 326 from a user portal 313. The processed data set 316 from the different feeds may be compiled into a unified layer 330 for further processing, e.g., through a selective masking pipeline 334. The raw data set 302 and processed data set 316 make up a secured and governed ingestion and processing step 328 of an aspect of the present disclosure.

The processed data set 316 from the different feeds compiled into the unified layer 330 is processed to identify PII within the unified layer 330 and to identify context proximate to the identified PII (as described hereinbefore with respect to FIG. 1B, to form a derived data set 332. The derived data set 332, processed through the unified layer 330, may be selectively masked 334 to produce a masked data set 326. The unmasked PII may be stored in an unmasked data set 344 formed from the derived data set 332 or unified layer 330.

The masked data set may include unique identifiers to mask the PII creating a unique identifiers masked data set 338. The masked PII may be stored in a reference table 340 cross-referencing the unique identifiers. The unique identifiers masked data set 338 and reference table 342 may be provided in a data set output 342. The unique identifiers masked data set 338 may be stored separately from the reference table 340 to prevent unauthorized access of the unmasked PII. Identifiers in the unique identifiers masked data set 338 may be cross referenced to the reference table if a request to unmask PII is received from an authorized user. As a result, the unique identifier may allow retrieval of the correlating unmasked PII from the reference table without requiring unmasking of all PII in the data set output 342. The data set output 342 such as the unique identifiers masked data set 338 and reference table 340 form a post-processing consumption layer 346. The data set output 342 such as the unique identifiers masked data set 338 and reference table 340 of the consumption layer 346 may be displayed on a graphical user interface 348. An authorized user may also access the unmasked data set 344 for display on the graphical user interface 348.

FIG. 3b is a schematic diagram of a system 349 according to another aspect of the present disclosure. A raw data set 350 may be provided. An exemplary embodiment may include a raw data set 350 comprising a data provider feed #1, 352, a data provider feed #2, 354, a data provider feed #3, 356, a data provider feed #4, 358, and a portal uploaded feeds 360 from a user portal 361. The raw data set 350 may be received through an ingestion pipeline 362.

The raw data set 350 may be analyzed to identify a location in the raw data set 350 that has PII, and to identify the context proximate to the PII. The context may be identified by a context identifier 364 configured to analyze the raw data set 350 and discern PII from contextual information (as described hereinbefore with respect to FIG. 1B. The context identifier 364 ensures only the PII is flagged for masking, leaving the context unmasked to preserve any information not flagged as protected. The inclusion of the context identifier 364 improves on prior methods of masking by preventing over or under masking resulting from an inability to locate and separate context from the PII.

Previous methods, as described above, included flagging entire documents or data sets as requiring masking if any PII is detected within the document or data set. Other methods required masking entire sections of a document or data set where PII is expected to prevent missing any PII and risking exposure of sensitive or confidential information. These overzealous methods led to a loss of useful and valuable contextual information, reducing the value and comprehensibility of the data set and preventing effective analysis of any data contained within the document or data set.

By utilizing a context identifier 364 configured to analyze the raw data set 350 and discern PII from contextual information (as described hereinbefore with respect to FIG. 1B, a masking process is provided which overcomes prior limitations and enables selective masking of only selected PII or specifically protected information. Thus, the value, comprehension, and quality of the data set can be preserved by ensuring context useful for study and analysis of the data set is not masked. Additionally, the context identifier 364 may use the context identified to help review identification of detected PII to prevent accidentally including non-PII in the flagged data to be masked.

The raw data set 350 is processed to form a processed data set 366. Processing may include filtering to remove null fields, string containers, etc., as discussed hereinbefore. The raw data set 350 and processed data set 366 are part of a secured and governed ingestion and processing step 368. The processed data set 366 may be used to form a unified layer 370 including the identified context and PII. The unified layer 370 may also form a derived data set 372. An unmasked data set 384 may be stored as a copy of the unified layer 370 or the derived data set 372.

Selective masking 374 is performed on the unified layer 370 or derived data set 372 to form a masked data set 376. Unique identifiers may be added to any locations with masked PII for identifying the type of PII masked forming a unique identifiers masked data set 378. The unique identifiers may be cross-referenced with a reference table 380 storing the masked PII. As a result, an authorized user can unmask selected PII using the unique identifiers to retrieve the masked PII from the reference table 380. The unique identifiers masked data set 378 and reference table 380 may create a dataset output 382. An authorized user may be able to access the unmasked data set 384 as part of the dataset output 382. The dataset output 382 forms a consumption layer 386 that may be stored, and accessible by a user to review the masked data set 378 or unmasked data set 384 depending on the user's authorization. The consumption layer 386 may be displayed on a graphical user interface 388 to enable review by the user.

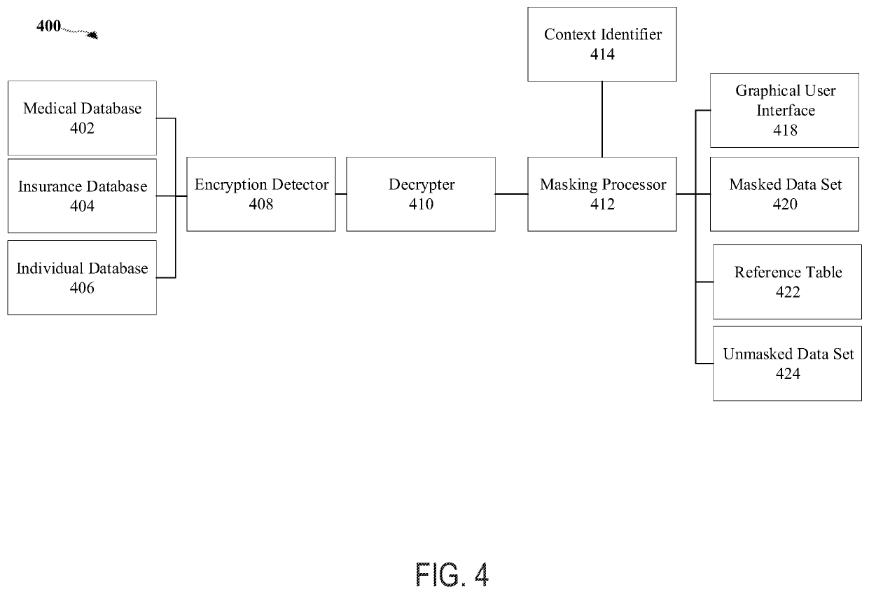

FIG. 4 is a flow diagram of a method 400 of selectively masking PII according to one aspect of the present disclosure. Data may be provided from various sources such as a medical database 402, an insurance database 404, an individual database 406, or other data sources. The individual database may include information provided by a user on submitted forms, a local server or database connected to the internet, or during communications with a customer service representative. An encryption detector 408 determines if the data is encrypted. If the data is encrypted and cannot be analyzed, the data may be decrypted via a decrypter 410.

A processor, such as a masking processor 412, receives the data and utilizes a context identifier 414 configured to analyze the data and discern PII from contextual information (as described hereinbefore with respect to FIG. 1B to identify at least one location having PII and context proximate to the PII. In an exemplary embodiment, the context identifier 414 may analyze text based information to the left or right of the PII's location to determine whether the text based information is part of the PII or contextual. If the text based information is contextual it is not flagged for masking to ensure only the PII is masked in a selective masking process.

The data may be recorded in an unmasked data set 424 without masking to preserve all data provided for analysis by authorized users. A masked data set 420 may be created by masking any flagged PII. The masking processor 412 may identify the type of PII identified at a location. As part of the selective masking process, only selected types of PII may be masked while other types of PII are left unmasked. An identifier may be placed at the masked location for identifying what type of PII was masked. For example, if the PII masked is “Jane Smith” the identifier may be “NAME.”

Additionally, a unique identifier may be used. The unique identifier may cross-reference a reference table 422 containing the masked PII to enable unmasking by an authorized user. In an exemplary embodiment, the name “Jane Smith” may be masked with the identifier “NAME42.” The reference table 422 may correlate “NAME42” with “Jane Smith.” As a result, an authorized user may review the masked data set 420 and, seeing “NAME42,” decide they desire to view the masked PII as part of their review. The user may choose to unmask “NAME42” which pulls the masked information from the reference table 422. The user may interact with the unmasked data set 424 and masked data set 420 using a graphical user interface 418.

Various aspects of the disclosure have been described fully above with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus or system may be implemented or a method may be practiced using any number of the aspects set forth. In addition, the scope of the disclosure is intended to cover such an apparatus, system or method which is practiced using other structure, functionality, or structure and functionality in addition to or other than the various aspects of the disclosure set forth. It should be understood that any aspect of the disclosure disclosed may be embodied by one or more elements of a claim.

The word “exemplary” or “illustrative” are used herein to mean “serving as an example, instance, or illustration.” Any aspect described herein as “exemplary” or “illustrative” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method of selectively masking a PII comprising:
providing at least one data file including the PII through an ingestion pipeline and creating a raw data set;
reading the raw data set;
filtering the raw data set;
analyzing the raw data set for determining at least one location including the PII;
identifying the PII in the at least one location and categorizing the PII as a type of PII;
recording the type of PII in a data field;
selectively masking the PII;
wherein selectively masking the PII includes analyzing the at least one location to determine a context proximate to the PII and masking only the PII;
outputting a masked data set including the at least one data file with the PII selectively masked and the data field containing a record of the type of PII selectively masked.

2. The method of selectively masking the PII of claim 1 further comprising determining if the data file is encrypted and decrypting the data file into an editable state.

3. The method of selectively masking the PII of claim 1, wherein the type of PII is recorded as one of a group including: a name, a date, a location, a Social Security Number, an email, a zip code, and a phone number.

4. The method of selectively masking the PII of claim 1 further comprising providing at least two data files including the PII through an ingestion pipeline and unifying the at least two data files into the raw data set.

5. The method of selectively masking the PII of claim 1 wherein the masked data set is configured to display the context in plain text on a graphical user interface.

6. The method of selectively masking the PII of claim 1 wherein the masked data set includes an indicator at the at least one location, the indicator configured to identify the type of PII selectively masked.

7. The method of selectively masking the PII of claim 6 wherein the masked data set is configured to be selectively demasked by an authorized user reviewing the indicator.

8. The method of masking the PII of claim 1 wherein selectively masking further comprises masking only the PII identified as at least one selected type of PII.

9. An apparatus for selectively masking PII, comprising:
a memory; and
at least one processor coupled to the memory, the at least one processor configured:
to receive at least one data file including the PII through an ingestion pipeline and create a raw data set;
to read the raw data set;
to filter the raw data set;
to analyze the raw data set for determining at least one location including the PII and contextual information;
to identify the PII in the at least one location and categorize the PII as a type of PII;
to record the type of PII in a data field; and
to selectively mask the PII without masking the contextual information;
to output a masked data set including the at least one data file with the PII selectively masked and the data field containing a record of the type of PII selectively masked.

10. The apparatus of claim 9, in which the at least one processor is further configured:
to determine if the data file is encrypted and decrypt the data file into an editable state.

11. The apparatus of claim 9, in which the at least one processor is further configured:
to record the type of PII as one of a group including: a name, a date, a location, a Social Security Number, an email, a zip code, and a phone number.

12. The apparatus of claim 9, in which the at least one processor is further configured:
to provide at least two data files including the PII through an ingestion pipeline and unify the at least two data files into the raw data set.

13. The apparatus of claim 9, in which the at least one processor is further configured:
to display the context of the masked data set in plain text on a graphical user interface.

14. The apparatus of claim 9, in which the at least one processor is further configured:
to include an indicator at the at least one location, the indicator configured to identify the type of PII selectively masked.

15. The apparatus of claim 14, in which the at least one processor is further configured:
to enable the masked data set to be selectively demasked by an authorized user reviewing the indicator.

16. The apparatus of claim 9, in which the at least one processor is further configured:
to mask only the PII which is identified as at least one selected type of PII.

17. A non-transitory computer-readable medium having program code recorded thereon, the program code executed by a processor and comprising:
program code to provide at least one data file including the PII through an ingestion pipeline and creating a raw data set;
program code to read the raw data set;
program code to filter the raw data set;
program code to analyze the raw data set for determining at least one location including the PII;
program code to identify the PII in the at least one location and categorize the PII as a type of PII;
program code to record the type of PII in a data field;
program code to selectively mask the PII;
program code to analyze the at least one location to determine a context proximate to the PII and mask only the PII;
program code to output a masked data set including the at least one data file with the PII selectively masked and the data field containing a record of the type of PII selectively masked.

18. The non-transitory computer-readable medium of claim 17, in which the program code further comprises:
program code to determine if the data file is encrypted and decrypt the data file into an editable state.

19. The non-transitory computer-readable medium of claim 17, in which the program code further comprises:
program code to record the type of PII as one of a group including: a name, a date, a location, a Social Security Number, an email, a zip code, and a phone number.

20. The non-transitory computer-readable medium of claim 17, in which the program code further comprises:
program code to provide at least two data files including the PII through an ingestion pipeline and unify the at least two data files into the raw data set.
